(19) United States
(12) Patent Application Publication
(10) Pub. No.: US 2004/0118770 A1
(43) Pub. Date: Jun. 24, 2004

(54) Multiple layer membrane and method for fabrication thereof

(76) Inventors: Richard D. Sale, Tolland, CT (US); Anna Bailey, Wallingford, CT (US); Jeffrey A. Lucas, Clinton, CT (US); C. Thomas Paul, Madison, CT (US)

Correspondence Address: MCCARTER & ENGLISH LLP, CITYPLACE I, 185 ASYLUM STREET, HARTFORD, CT, 06103, US

(21) Appl. No.: 10/626,684

(22) Filed: Jul. 24, 2003

Related U.S. Application Data
(60) Provisional application No. 60/398,093, filed on Jul. 24, 2002.

(51) Int. Cl. B01D 29/00

(52) U.S. Cl. 210/488; 210/483; 210/489

(57) ABSTRACT

Phase inversion microporous membranes including at least two different pore size regions are provided, wherein two membrane sheets are placed, back-to-back, such that the qualifying pore zones are positioned internally within the structure. Exemplary membranes according to the present disclosure provide excellent thermal stability and retention characteristics. Methods for fabricating and using the disclosed membrane structures are also provided according to the present disclosure.

### CROSS REFERENCE TO RELATED APPLICATIONS

The present application claims the benefit of a commonly assigned, co-pending provisional patent application entitled “Multiple Layer Membrane And Method For Fabrication Thereof,” filed on Jul. 24, 2002 and assigned Ser. No. 60/398,093, the entire contents of which are hereby incorporated by reference.

### BACKGROUND OF THE DISCLOSURE

1. Technical Field

The present disclosure relates to a phase inversion cast membrane fabricated from nylon, polyvinylidene fluoride and/or polyethersulfone having at least two different pore size regions, wherein two membrane sheets are placed back-to-back, such that the qualifying pore zones are positioned internally within the structure. Exemplary membranes according to the present disclosure provide excellent thermal stability and retention characteristics. Methods for fabricating and using the disclosed membrane structures are also provided according to the present disclosure.

2. Background

Microporous phase inversion membranes are well known in the art.

Microporous phase inversion membranes are porous solids which contain microporous interconnecting passages that extend from one surface to the other. These passages provide tortuous tunnels or paths through which the liquid which is being filtered must pass. The particles contained in the liquid passing through a microporous phase inversion membrane generally become trapped on or in the membrane structure to effectuate filtration. A slight pressure, generally in the range of about two (2) to about fifty (50) psid (pounds per square inch differential) is typically used to force fluid through the microporous phase inversion membrane. The particles in the liquid that are larger than the pores are either prevented from entering the membrane or are trapped within the membrane pores and some particles that are smaller than the pores are also trapped or absorbed into the membrane pore structure within the pore tortuous path. The liquid and some particles smaller than the pores of the membrane pass through. Thus, a microporous phase inversion membrane prevents particles of a certain size or larger from passing through it, while at the same time permitting liquid and some particles smaller than that certain size to pass through. Microporous phase inversion membranes typically have the ability to retain particles in the size range of from about 0.01 or smaller to about 10.0 microns or larger.

Many micron and submicron size particles having commercial and/or clinical significance can be separated using microporous membranes. For example, red blood cells are about eight (8) microns in diameter, platelets are about two (2) microns in diameter and bacteria and yeast are typically about 0.5 microns or smaller in diameter. It is possible to remove bacteria from water by passing the water through a microporous membrane having a pore size smaller than the bacteria. Similarly, a microporous membrane can remove invisible suspended particles from water used in the manufacture of integrated circuits in the electronics industry.

Microporous membranes are characterized by bubble point tests, which involve measuring the pressure to force either the first air bubble out of a fully wetted phase inversion membrane (the initial Bubble Point, or “IBP”), and the higher pressure which forces air out of the majority of pores all over the phase inversion membrane (foam-all-over-point or “FAOP”). The procedures for conducting initial bubble point and FAOP tests are discussed in U.S. Pat. No. 4,645,602, issued Feb. 24, 1987, the disclosure of which is herein incorporated by reference. Procedures that have been used for the initial bubble point test and the more common Mean Flow Pore tests are explained in detail, for example, in ASTM F316-70 and ANS/ASTM F316-70 (Reapproved 1976), which are incorporated herein by reference. The bubble point values for microporous phase inversion membranes are generally in the range of about five (5) to about one hundred (100) psig, depending on the pore size and the wetting fluid.

An additional pore measurement technique is described in ASTM E1294 89, which describes a method for determining pore size by clearing fluid from the pores of the membrane and measuring the resulting flow. This method is used to measure mean flow pore and is similar to the method of Forward Flow Bubble Point referenced herein above in that the wet portion of the ASTM E1294 89 test uses a similar protocol.

Various prior art patents are directed to microporous membranes and methods for manufacture and use of microporous membranes. For example, U.S. Pat. No. 3,876,738 to Marinaccio et al. describes a process for preparing microporous membranes by quenching a solution of a film-forming polymer in a non-solvent system for the polymer. U.S. Pat. No. 4,340,479 to Pall generally describes the preparation of skinless microporous polyamide membranes by casting a polyamide resin solution onto a substrate and quenching the resulting thin film of polyamide.

Since the mechanical strength of some microporous membranes is relatively poor, it is known to reinforce membranes with a porous support material to improve mechanical properties and facilitate handling and processing. Accordingly, the aforementioned U.S. Pat. No. 4,340,479 to Pall describes a procedure whereby a polymer solution is directly cast onto a porous support material so that the polymer solution penetrates the support material during casting and becomes firmly adhered thereto during formation of the reinforced inner layer of a composite microporous membrane. The support material preferably possesses an open structure so that pressure drop across the composite membrane is minimized. U.S. Pat. No. 4,340,479 further discloses combining two or more microporous membranes, one of which may be reinforced, to form a dual or triple layered structure which is dried under conditions of restraint to produce a single sheet having particle removal characteristics superior to those of individual layers.

U.S. Pat. No. 4,707,265 to Barnes, Jr., et al. discloses a reinforced laminated filtration membrane comprising a porous reinforcing web impregnated with a polymeric microporous inner membrane and at least one polymeric microporous outer qualifying membrane laminated to each side of the impregnated web. The pore size of the inner membrane is greater than the pore size of the outer membranes. In this manner, the imperfections, e.g., fiber bundles, broken fibers, void areas, and the like, which are invariably present in the reinforcing web are confined to a coarse, more open inner membrane and the tighter outer qualifying layers are strengthened and supported by the web. The qualifying layers are not affected by imperfections present within the reinforcing web. Further, the use of a coarse, large pore size inner membrane layer insures that there is no substantial pressure drop of fluid across the reinforcing web.

The membranes disclosed in the foregoing U.S. Pat. No. 4,707,265 to Barnes, Jr., et al. are complicated and costly to produce since three separate operations are required to produce the composite membrane: first, the impregnated reinforced membrane support layer is produced, second, the non-reinforced qualifying layers are produced and, third, the impregnated reinforced membrane support layer and the non-reinforced qualifying layers are laminated to form the multilayer composite microporous membrane. This structure is further limited in that the qualifying zones are exposed to potential damage during cartridge fabrication. Furthermore, when the two qualifying zones are separated, a defect in one layer can allow contaminant to by pass it and laterally flow through the more open zone until it finds a defect in the second layer. Defects create preferential flow paths over the controlled pores to the square of their diameter.

Furthermore, the overall pore size of the composite membrane described in the Barnes '265 patent is generally limited to the range of approximately 0.45 microns or lower due to the difficulties of separately producing and handling non-reinforced qualifying layers having pore sizes of as high as about 0.45 microns. Thus, the utility of the laminated composite membrane is generally limited to sterilizing applications and other applications where membranes having about 0.65, 0.8, 1.2, 3.0 and greater micron ratings are not needed. Furthermore, a mechanical strain exists at the crest of each pleat and increases with increasing thickness which is especially troublesome when the tight layers are exposed. Therefore, mechanical strains, which can never be fully relieved after cartridge fabrication, may decrease the useful life of the product and may lead to early failure in integrity.

U.S. Pat. No. 4,770,777 to Steadly et al. overcomes some of the shortcomings of the process disclosed in the Barnes '265 patent by completely saturating the reinforcing web with a large pore size (coarser) membrane casting solution, applying a small pore size membrane casting solution on one side of the coated web and then quenching the large and small pore size casting solutions from only one side to provide a continuous, geometrically asymmetric membrane possessing a pore size gradient. Thus, the lamination step of the Barnes '265 patent is eliminated, along with the necessity of handling the fragile non-reinforced qualifying layers. However, following the teachings of the Steadly '777 patent, it is not possible to apply another casting solution on the other side of the large pore size reinforced web containing layer. Thus, the only additional layers can be cast on top of the second layer that is cast on the first layer and that includes the woven material. Additionally, the membrane taught in the Steadly '777 patent is a skinned membrane. Accordingly, such membrane suffers from drawbacks associated with skinned microporous membranes, in particular, high pressure drop, relatively poor structural integrity, susceptibility to skin breach, propensity to becoming fouled by debris, etc.

U.S. Pat. No. 5,433,859 to Degen attempts to address some of the deficiencies, in particular, high pressure drop, of the skinned membrane disclosed in U.S. Pat. No. 4,770,777 to Steadly et al., by proposing, preferably, an incomplete impregnation of the reinforcing web with coarse membrane casting solution so that a portion of the reinforcing web having a thickness of about 50 microns is not embedded within the microporous membrane. The low flow resistance of that portion of the reinforcing web which is not embedded within the microporous membrane ensures that filtered fluid passing through the supported microporous membrane will not have a significant adverse impact on the pressure drop across the filtration element.

While the membrane disclosed in the Degen '859 patent exhibits lower pressure drop across the membrane compared to the skinned membrane disclosed in U.S. Pat. No. 4,770,777, the membrane does have significant structural drawbacks. First, the membrane suffers from tremendous geometric asymmetry around the central axis of the reinforcing web, i.e., the thickness of the membrane varies on each side of the reinforcing web. As a result, when the membrane is pleated, the mechanical strain on the thick side of the membrane is greater than on the thin side of the membrane. This differential in mechanical strain increases the possibility of stress crack formation and failure of the integrity of the membrane. Second, the membrane poses a possible risk of separation along the membrane-reinforcing web interface, especially during backwashing operations. Third, the membrane exhibits “sidedness,” having a different pore size on one side versus the other side and an exposed scrim reinforcement area. This will limit its utility in certain applications such as analytical, or some diagnostic filtration techniques. Finally, as with the Steadly '777 patent, the membrane of the Degen '859 patent cannot have another section on the opposite side of the membrane-reinforced web for the same reason as the Steadly '777 patent.

More recently, U.S. Pat. No. 6,264,044 to Meyering et al., discloses advantageous three-region reinforced microporous filtration membranes and methods for manufacture of such microporous filtration membrane systems. With particular reference to U.S. Pat. No. 6,264,044, the disclosure of which is herein incorporated by reference, three zone, reinforced, continuous, geometrically symmetrical microporous membranes are disclosed that include a porous support material encapsulated within a middle zone disposed between an upper zone and lower zone. At least one of the three zones has a pore size at least about twenty percent (20%) greater than the pore size of the other two zones. The performance of the disclosed three zone microporous membrane systems of the Meyering '044 patent is characterized by improved flow rates in filtration applications (based on pore size attributes), relatively thin cross-sections that result in membrane cartridges having greater surface area and higher throughput.

U.S. Pat. No. 6,280,791 to Meyering et al., the disclosure of which is herein incorporated by reference, discloses an advantageous process for making a reinforced, continuous, geometrically symmetrical microporous filtration membrane, wherein the membrane includes a porous support material and a continuous microporous membrane having a middle region disposed between an upper region and a lower region. The support material of the Meyering '791 patent is embedded within the middle region and the middle region has a pore size at least about fifty percent (50%) greater than the pore size of at least one of the upper and lower regions. The upper and lower regions possess substantially the same thickness so as to provide geometric symmetry around the central axis of the membrane. The disclosed fabrication process may be practiced in a continuous or batch-wise manner. The Meyering process represents an improvement over the Barnes process in that the membrane can be fabricated all at once and does not require lamination. However, the Meyering process does not place the two qualifying zones in immediate proximity.

Despite the significant efforts devoted to developing advantageous microporous filtration membrane systems to date, there remains a need for enhanced filtration membrane designs that offer superior filtration performance, thermal stability, and enhanced levels of contaminant protection. In addition, a need remains for microporous filtration membrane systems that provide reliable and efficacious filtration performance in a variety of finished industrial forms (e.g., pleated cartridges, etc.) and that are relatively inexpensively, reliably and easily manufactured.

### SUMMARY OF THE DISCLOSURE

An object of the present disclosure is to provide a microporous, membrane possessing enhanced thermal stability and throughput capabilities.

Another object of the present disclosure is to provide a microporous membrane that provides physical and contaminant protection to the membrane's qualifying layer(s).

A further object of the present disclosure is to provide a microporous membrane that provides efficacious filtration of biological fluids, parenteral fluids, industrial processing fluids, and the like.

A further object of the present disclosure is to provide a microporous membrane whose design can compensate for potential flaws in the manufacture of the membrane.

Yet a further object of the present disclosure is to provide a microporous membrane having the advantageous properties described herein that may be fabricated using nylon, polyvinylidene fluoride and/or polyethersulfone.

Another object of the present disclosure is to provide a method for manufacturing a microporous, non-charge modified membrane having the advantageous properties described herein.

In accordance with these and further objects, an exemplary microporous membrane according to the present disclosure includes a phase inversion cast membrane fabricated from nylon, polyvinylidene fluoride and/or polyethersulfone having at least two different pore size regions. Two layers of the membrane are positioned or laid in a side-by-side manner, and are preferably laminated to each other, “back-to-back,” so that the tight, i.e., qualifying, regions are sandwiched in the center of the membrane. Laminated and non-laminated microporous membranes according to the foregoing design provide protection to the qualifying layers, e.g., during further processing (e.g., pleating), and deliver enhanced filtration throughput capabilities. Exemplary laminated and non-laminated microporous membranes according to the foregoing design feature a sturdy construction that provides for excellent thermal stability, and robustness against potential flaws in the qualifying layers.

A further exemplary microporous membrane according to the present disclosure includes two phase inversion cast membranes, wherein at least one membrane and preferably both membranes have at least (but not limited to) two different pore sizes. The two membranes are laminated to each other such that the qualifying layers are placed together. The two qualifying layers are thus positioned such that they are at the center of the laminated structure, where they will be substantially protected from potential damage. Such exemplary microporous membrane design is particularly suitable for sterilizing filter media, although the microporous membrane may be effectively utilized in a variety of industrial and/or clinical applications. The presence of the more open layer(s) (e.g., the prefilter layers) on the outside of the microporous membrane not only provides physical protection, but also protects the tighter layers (i.e., the qualifying layers) from contaminants during use. The disclosed microporous membrane design offer significant advantages, including extended filter life.

Other objects and advantages of the invention will be apparent from the following description, the accompanying drawings and the appended claims.

### BRIEF DESCRIPTION OF THE DRAWINGS

So that those of ordinary skill in the art to which the subject disclosure pertains will more readily understand how to make and use the microporous membranes described herein, preferred embodiments will be described herein with reference to the drawings, wherein:

FIG. 1 is a schematic cross-section of an exemplary microporous membrane according to the present disclosure;

FIG. 2 is a schematic representation of a method and apparatus for use in an exemplary manufacturing process according to the present disclosure;

FIGS. 3a and 3b are scanning electron photo micrographs of exemplary microporous membranes according to the present disclosure; and

FIG. 4 is a schematic cross-section of an alternative exemplary microporous membrane according to the present disclosure.

### DETAILED DESCRIPTION OF PREFERRED EMBODIMENT(S)

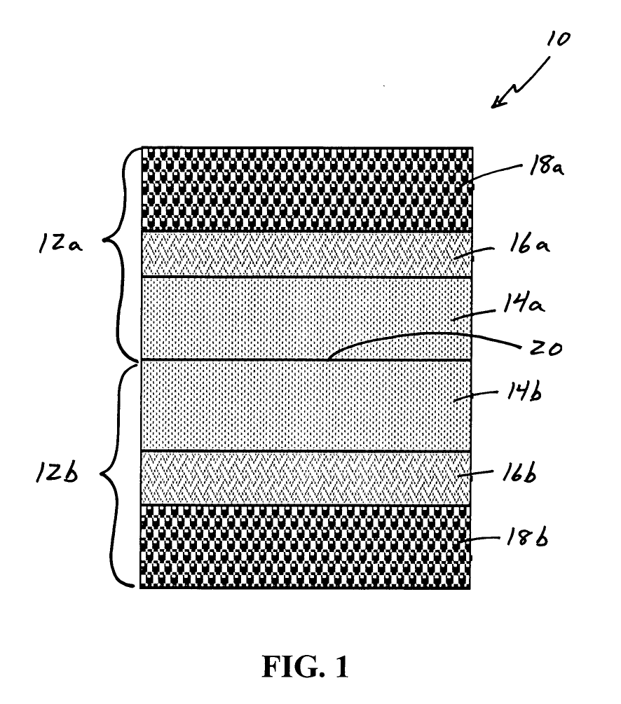

A representative, presently preferred, exemplary microporous membrane 10 according to the present disclosure is schematically depicted in FIG. 1. The schematically depicted structure is appropriate for reinforced membranes, e.g., membranes fabricated from nylon. However, microporous membranes fabricated from polyvinylidene fluoride (PVDF) and/or polyethersulfone (PES) according to the present disclosure generally do not require reinforcement in the middle of the membrane. Microporous membrane 10 is formed by placing or laying individual microporous membrane members 12a, 12b in a side-by-side or back-to-back relationship.

According to a preferred embodiment of the present disclosure, microporous membrane is formed through lamination of a pair of individual microporous membrane members 12a, 12b. In the schematically depicted microporous membrane 10, membrane member 12a includes a qualifying layer 14a, a reinforcement layer 16a, and a prefilter layer 18a. In like measure, membrane member 12b includes a qualifying layer 14b, a reinforcement layer 16b, and a prefilter layer 18b. Both microporous membrane member 12a and microporous membrane member 12b are typically continuous, i.e., a continuum exists between the filtering layers thereof.

As noted above, preferred microporous membranes according to the present disclosure may be fabricated from polyvinylidene fluoride and/or polyethersulfone. Based on the structural properties of microporous membranes fabricated from PVDF and/or PES, reinforcement layers (e.g., layers 16a, 16b) are generally not required. In the case of an unreinforced membrane, the prefilter layer and the qualifying layer would be adjacent to each other.

Microporous membrane 10 is preferably formed by laminating membrane member 12a and membrane member 12b such that the qualifying layers 14a, 14b are laminated to each other along a lamination plane 20. It is further contemplated that microporous membrane 10 may be formed by positioning or laying membrane members 12a, 12b in side-by-side relation prior to the pleating operation. According to preferred embodiments of the present disclosure, membrane member 12a is typically the same as membrane member 12b, i.e., the same membrane material (subject to standard manufacturing variability) is essentially laminated to itself. Microporous membrane 10 is thus typically symmetrical relative to an interface or lamination plane 20.

Use of the term “microporous membrane” herein is intended to encompass microporous membranes having the ability to retain particles in the size range of from about 0.01 or smaller to about 10.0 microns and higher.

The term “continuous” as applied to microporous membranes according to the present disclosure shall be understood to refer to microporous membranes wherein a continuum exists between the zones constituting the membrane and that no break exists between the polymer structure which comprises the individual filtration zones thereof. The microporous membrane structure shall be considered a continuous structure even in the presence of a reinforcing layer or scrim, in that the fiber strains of the reinforcing layer or scrim constitute a network relative to which the microporous membrane structure is continuous and penetrating. Therefore, the scrim and the microporous membrane form continuous interpenetrating networks of their respective polymeric structures.

The term “monolithic” as applied to microporous membranes according to the present disclosure is intended to mean a single unit.

The phrase “geometric symmetry” utilized herein shall be understood to refer to a structure wherein the symmetric zones or layers of the microporous membrane possess substantially the same thickness. It is worthy of note that the term “symmetry” is employed differently herein as contrasted with use of the term “symmetry” in U.S. Pat. No. 4,707,265 to Barnes, Jr., et al. The Barnes '265 patent uses the term “symmetry” to refer to pore size symmetry; thus, in the Barnes '265 patent, the term “symmetry” applies when the outer qualifying layers possess substantially the same pore size. For certain embodiments of the present disclosure, pore size symmetry is a preferred, but not essential, characteristic of the exemplary microporous membranes disclosed herein.

The term “pore size” as used in the present disclosure shall be understood to mean “Mean Flow Pore,” as determined by the appropriate ASTM-F316-70 and/or ASTM-F316-70 (Reapproved 1976) tests and/or by the pore measurement technique described in ASTM E1294 89.

Microporous membranes according to the present disclosure are hydrophilic. By the use of the term “hydrophilic,” it is meant a membrane that adsorbs or absorbs water. Generally, such hydrophilicity is enhanced in the presence of a sufficient amount of hydroxyl (OH—), carboxyl (—COOH), amino (—NH₂) and/or similar functional groups on the surface of the membrane. The disclosed microporous membranes may be intrinsically hydrophilic, such as microporous membranes fabricated from nylon, or may be rendered hydrophilic by a post treatment operation, such as post-treated microporous membranes fabricated from PVDF. Additionally, hydrophilicity is enhanced by micro textural phenomena, as described by Knight, Gryte & Hazlett. Such groups assist in the adsorption and/or absorption of water onto the membrane. Such hydrophilicity is particularly useful in the filtration of aqueous fluids.

Exemplary microporous membranes according to the present disclosure are produced from nylon. The term “nylon” is intended to embrace film forming polyamide resins including copolymers and terpolymers which include the recurring amido grouping and blends of different polyamide resins. Preferably, the nylon is hydrolytically stable. This might be achieved by various means as are known in the art, such as increasing the number of amino end groups as disclosed in U.S. Pat. No. 5,458,782 to Hou et. al., the contents of which are incorporated by reference herein, or by increasing the molecular weight of the nylon, or by adding antioxidant(s) to the nylon.

Generally, nylon and polyamide resins are copolymers of a diamine and a dicarboxylic acid, or homopolymers of a lactam and an amino acid, and they vary widely in crystallinity or solid structure, melting point, and other physical properties. Preferred nylons for use in fabricating microporous membranes according to the present disclosure include copolymers of hexamethylene diamine and adipic acid (nylon 66), copolymers of hexmethylene diamine and sebacic acid (nylon 610), homopolymers of polycaprolactam (nylon 6) and copolymers of tetramethylenediamine and adipic acid (nylon 46). These preferred polyamide resins have a ratio of methylene (CH₂) to amide (NHCO) groups within the range of about 4:1 to about 8:1. Nylon polymers are available in a wide variety of grades, which vary appreciably with respect to molecular weight, within the range from about 15,000 to about 42,000 (number average molecular weight) and in other characteristics. A highly preferred species of the units composing the polymer chain is polyhexamethylene adipamide, i.e. nylon 66, having molecular weights above about 30,000. Polymers free of additives are generally preferred, but the addition of antioxidants, surface active agents, or similar additives may have benefit under some conditions.

As used herein, a “microporous membrane” is a porous solid containing microporous interconnecting passages that extend from one surface to the other. These passages generally provide tortuous tunnels or paths through which a liquid being filtered must pass. Any particles contained in this liquid that are larger than the pores are either prevented from entering the microporous membrane or are trapped within the pores of the microporous membrane. Some particles that are smaller than the pores are also trapped or absorbed into the pore structure of the microporous membrane within the tortuous path. The liquid and some particles smaller than the pores pass through the microporous membrane. As noted above, microporous membranes of this type have the ability to retain particles that range in size from about 0.01 or smaller to about 10.0 microns or larger.

As used herein, “phase inversion” or “phase inverted membrane” refers to a process of exposing a polymer solution to a controlled environment so as to form a latent pore structure. Phase inversion is a necessary step in the formation of a microporous membrane and occurs after the polymer solution has been coated or applied to a surface or a substrate. As is well known by persons skilled in the art, the phase inversion process may be induced by a number of mechanisms. Examples of phase inversion include, but are not limited to, (i) contacting a polymer solution coating to a solution of solvent and nonsolvent containing a higher percentage of nonsolvent than the polymer solution, (ii) thermally induced phase inversion, and (iii) exposing a membrane to a vapor interface and evaporating the solvent from the polymer solution coating. In some cases, the preparation that has been cast, phase inverted, and rinsed but not dried may also be called a membrane, although it should be understood that a final membrane embodiment is only achieved after drying.

With further reference to the schematic depiction of FIG. 1, prefilter layers 18a, 18b are microporous membranes that have a more open structure or larger pores than qualifying layers 14a, 14b. Prefilter layers 18a, 18b constitute the most external surfaces of microporous membrane 10. According to exemplary embodiments of the present disclosure, the pore structures of prefilter layers 14a, 14b are substantially homogeneous and symmetric with respect to their depth.

Reinforcement layers 16a, 16b are typically nonwoven supports that are typically fabricated from a polyolefin or polyester. Reinforcement layers 16a, 16b provide support to membrane members 12a, 12b, and once laminated to each other, to microporous membrane 10. Although the exemplary microporous membrane 10 depicted in FIG. 1 includes reinforcement layers 16a, 16b, it is contemplated that, depending upon the manufacturing technique or the polymeric materials used to fabricate the qualifying and prefilter layers, e.g., in the case of qualifying and/or prefilter layers fabricated from PVDF or PES, reinforcement layer(s) may not be required.

Qualifying layers 14a, 14b are microporous membranes that have smaller pores than the prefilter layers 18a, 18b,. The pore structures of the qualifying layers 14a, 14b are substantially homogeneous and are generally symmetric with respect to their depth. The pore sizes/properties of the qualifying layers 14a, 14b define the overall retention characteristics of microporous membrane 10.

Lamination of membrane member 12a and membrane member 12b generally consists of independently casting, phase inverting and rinsing the respective membrane members. However, the membrane members are not dried prior to the lamination step. Rather, membrane members 12a, 12b are pressed together into intimate contact (along lamination plane 20) prior to drying. The membrane members 12a, 12b are then dried together, with qualifying layer 14a in side-by-side, abutting relation with qualifying layer 14b, thereby creating a tight bond between them. It is further contemplated that one may wish to cast the qualifying and prefilter layer at one time, phase invert, and rinse, and then fold the membrane lengthwise such that the qualifying layer folds onto itself prior to drying.

The two layers are pressed in contact prior to drying. This may be accomplished in a number of ways. In a tenter oven, the two layers are held in crosswise tension while drying. A tenter oven, which uses pins to hold the sides of the drying membrane in tension, works acceptably for a reinforced membrane but is less suitable for an unreinforced membrane. In the case of an unreinforced membrane, it is contemplated that the membranes can be pressed together with a nip roll prior to drying, or placed in intimate contact and processed within a vacuum roll dryer.

According to a preferred embodiment of the present disclosure, microporous membrane 10 is effective to function as a sterilizing filter medium. As used herein, a “sterilizing filter medium” is a membrane that completely removes B. diminuta bacteria from a liquid stream, even when challenged at concentrations of 10⁷ CFU /cm² of membrane surface area. The foregoing challenge protocol is defined by ASTM F838-83 or the Health Industries Manufacturer's Association (Document No. 3, Vol. 4).

Microporous membranes fabricated according to the present disclosure provide superior reliability in filtration performance. For example, sterilizing filtration grade membranes in many instances can suffer defects in the qualifying layer. Defects are highly significant in the qualifying layer(s) because of the extreme adverse risk associated with sterilization applications. A sterilizing filter that allows passage of even a few bacteria still represents a performance failure. Defects are sometimes associated with localized upsets in the coating process and may not be reliably compensated by making the membrane thicker. Moreover, there is ultimately a practical upper limit to how thick the membrane can be cast and still deliver an acceptable morphology. A very thick casting will not properly phase invert and will therefore provide an unacceptable structure.

By providing two independent qualifying layers and positioning or laying them side-by-side, e.g., by laminating them together as disclosed herein, the risk of a defect reaching through both qualifying layers is reduced substantially. The enhanced reliability associated with microporous membranes according to the present disclosure may be illustrated as follows. A sterilizing cartridge product may contain 1 m² of membrane surface area (typical cartridge constructions range from 0.46-1.02 m²) or 1 trillion square microns of surface area. If a single defect with a 5 micron diameter occurs within the media/membrane, the retention characteristics/properties of the media/membrane will be compromised. However, if the sterilizing cartridge product included another media layer of the same area with the same 5 micron diameter defect randomly located within it, the chance for alignment of the two defects would be only 0.000000031%, calculated as follows:

((r₁+3*r₂)²*π)/(1.0×10¹²)=0.000000031%.

In addition, lamination of the two membrane members to each other along a lamination plane reduces the likelihood that a particle will be able to effectively navigate from a defect in a first membrane element to an independent defect in the second membrane element. The potential for particle(s) to navigate from defect-to-defect would be increased if the two membranes were not effectively bonded to each other, thereby eliminating the potential for “free interchange” between respective membrane elements. Reducing separation between the layers removes this free fluid interchange and the two defects must be in almost exact proximity with one another. As the proximity between the membrane elements increases (and lamination according to the present disclosure significantly increases such proximity), the chance alignment of two defects becomes still more remote.

Lamination along a lamination plane, as disclosed herein, also reduces the effective thickness of the overall microporous membrane structure. The inevitable air gaps that exist between two unlaminated layers/membrane elements substantially reduces the amount of membrane surface area that can be packed into the filter cartridge. According to exemplary membrane embodiments of the present disclosure, lamination effectively removes the potential for such air gap(s).

In addition, the outward positioning of the prefilter layers on both sides of the microporous membranes according to the present disclosure provides additional advantages. First, the prefilter layers effectively sandwich and protect the qualifying layers from any further damage that might occur during processing and handling where, as noted above, defects can degrade the critical performance of the microporous membrane. The potential for damage and the protection afforded by the outwardly positioned prefilter layers are particularly evident during the pleating operation. Pleating is a typical manufacturing step in converting a sterilizing membrane to a commercial cartridge product. Pleating folds the membrane back and forth and bends the membrane onto itself. Pleating places the exterior surface of the membrane under the most stress. According to the present disclosure, the qualifying layers are on the neutral axis of either fold, regardless of whether the media is bent in or out, thereby minimizing the stress on the qualifying layers.

Moreover, as is known in the art, commercial cartridge products typically include upstream and downstream support members. Although functionally necessary, these support members can undesirably imprint and abrade the membrane, particularly during the pleating operation, thereby causing additional damage to the membrane. By sandwiching the qualifying layers within the prefilter layers, as disclosed herein, the qualifying layers are advantageously protected from damage that might otherwise be inflicted through imprinting/abrasion by the support members.

Additionally, positioning of the qualifying layers internally relative to the prefilter layers according to the present disclosure advantageously protects the qualifying layers from contaminants that might otherwise plug the pores thereof during filtration of fluids. Of note, minor damage to the prefilter layers, if it should occur (e.g., through abrasion by the support members), is not of great significance to the overall operability of the disclosed microporous membrane systems because the prefilter layer will generally still perform its intended prefiltering function. Minor defects in the prefilter layers are not particularly troublesome as they will still confer protection. Indeed, the prefilter layers exhibit much greater dirt holding capacity because of their larger pores, thereby conferring protection to the qualifying layers and increasing filtration life.

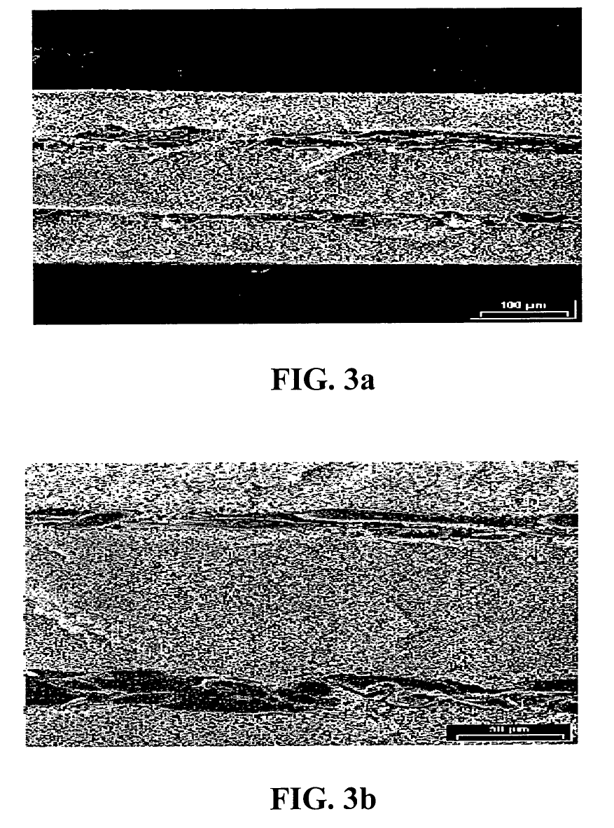

With reference to the scanning electron photo micrographs of FIGS. 3a and 3b, exemplary microporous membranes according to the present disclosure are shown. As shown in FIGS. 3a and 3b, a reinforcement layer is provided intermediate each of the qualifying layers and prefilter layers. As shown in FIGS. 3a and 3b, the exemplary microporous membrane made in accordance with the present disclosure includes a central qualifying layer (defined by two distinct, laminated qualifying layers), the central qualifying layer bounded by first and second reinforcement layers, and outwardly facing prefilter layers. As noted above, however, depending on the overall design and structure of a microporous membrane according to the present disclosure, it is contemplated that the reinforcement layers may be omitted from the disclosed microporous membrane(s). Thus, for example, microporous membranes in which the prefilter/qualifying layers are fabricated from a nylon generally require a reinforcement layer to function effectively in a cartridge, while in an exemplary alternative microporous membrane embodiment that includes prefilter/qualifying layers fabricated from a fluoropolymer, e.g., polyvinylidene fluoride (PVDF), does not generally require a reinforcement layer.

An exemplary process for manufacturing/fabricating a microporous membrane that does not include a reinforcement layer may utilize a non-porous support, e.g., a polyethylene terephthalate (PET) film support. The manufacturing/fabricating process may advantageously involve use of multiple coating apparatus mounted or positioned on the same side of the non-porous support. The coating apparatus apply two (2) substantially symmetric layers to the non-porous support, without a reinforcement layer. The two zone structure is cast, phase inverted, and rinsed but not dried, and then joined to another layer made in the same manner, such that the two qualifying layers adjoin. The non-porous support is typically removed after the phase inversion or rinsing step, and typically functions as an intermediate processing aid. The microporous membrane is then pressed and dried to form an advantageous product that is devoid of reinforcement layer(s).

In many applications, the pore size of the prefilter layer and the pore size of the qualifying layer can be advantageously matched to yield the greatest advantage in flow and filtration life according to the present disclosure. According to preferred embodiments of the disclosed microporous membrane, for many filtration applications, the pore size of the prefilter layer is approximately two (2) to four (4) times greater than the pore size of the qualifying layer. However, in certain applications, a closer match between the pore size of the prefilter layer and the qualifying layer is warranted. For example, if the process stream has received the benefit of prefiltration, then the pore sizes of the two layers might be beneficially matched with a pore size difference closer to 1.5:1. Identification and selection of an optimal pore size ratio for the prefilter and qualifying layers for specific filtration applications is well within the skill of persons skilled in the art, based on the present disclosure.

The geometric symmetry of the microporous membranes made in accordance with the present disclosure minimizes mechanical strains, reduces the likelihood of delamination or separation of the side-by-side arrangement of the membrane, and generally improves the structural integrity of the membrane. This may be particularly important to fan-fold pleated cartridge arrangements, where both sides of the microporous membrane are expected to bend equally well around the neutral (unyielding) axis of the reinforcing scrim. Such bending should result in an equal distribution of tension and compression forces in the pleat crests and troughs, such that neither side is burdened with an excessive tension or compression load, which would increase the possibility of damage and/or breach failure of the membrane at the pleat area.

According to preferred embodiments of the present disclosure, the prefilter layer(s) are advantageously fabricated to have a thickness sufficient to provide protection to the associated qualifying layer. The prefilter layer(s) are generally fabricated such that such prefilter layer(s) are of sufficient thickness to protect the qualifying layer(s) from the propagation of cracks during pleating. According to currently preferred embodiments of the microporous membranes of the present disclosure, the prefilter layer is at least about twenty five percent (25%) of the thickness of a single qualifying layer, or at least about 12.5% of the thickness of the side-by-side (preferably laminated) qualifying layers.

Of note, preferred microporous membrane embodiments according to the present disclosure generally include qualifying layers that are of substantially the same thickness.

The finished microporous membrane of the present disclosure may be rolled and stored for use under ambient conditions. It will be understood that the microporous membrane resulting from the present disclosure may be formed into any of the usual commercial forms, such as, for example, discs or pleated cartridges. For sterile filtration involving biological liquids, the microporous membrane of the present disclosure is typically sanitized or sterilized by autoclaving or hot water flushing. The disclosed microporous membrane is generally resistant to such treatments, particularly when a hydrolytically stable nylon is used as described hereinabove, and retains its structural integrity in use under such conditions.

The disclosed microporous membrane is easy to handle and readily formed into convoluted structures, e.g. pleated configurations.. Thus, exemplary microporous membranes according to the present disclosure are generally characterized by durability, strength, uniformity, lack of pinholes and bubble defects.

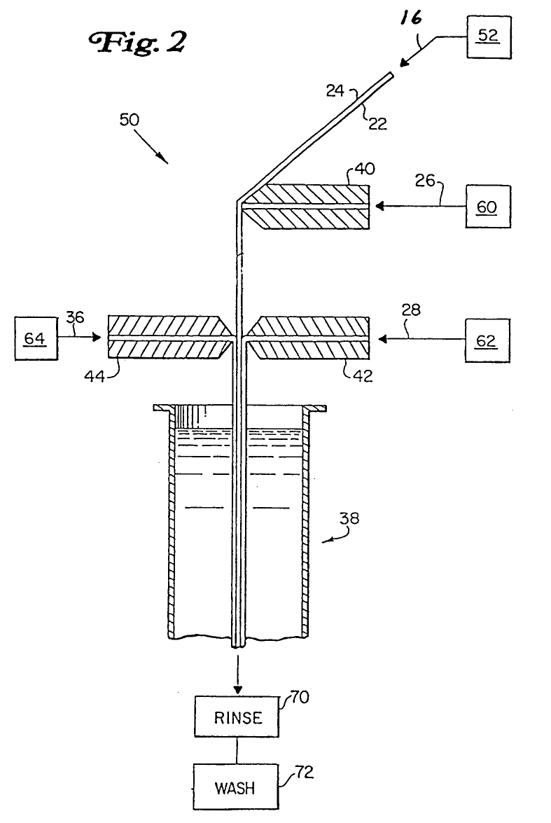

As illustrated in FIG. 2, one presently preferred method 50 for preparing a microporous membrane according to the present disclosure includes providing a reinforcement layer/material 16 having first and second sides 22, 24, respectively. Reinforcement layer/material 16 is pressure impregnated with a first solution or dope 26 on first side 22 and a second solution or dope 36 over the second side 24 of the reinforcement layer/material 16. As shown in FIG. 2, it is further contemplated according to method 50 that a third solution or dope 28 may be applied to the first side 22 of the reinforcement layer/material 16, such that a three zone microporous membrane is formed. Advantages associated with and exemplary structures for three zone microporous membranes are disclosed in U.S. Pat. No. 6,264,044 to Meyering et al., the disclosure of which has previously been herein incorporated by reference. Thus, as disclosed herein, exemplary microporous membranes are not limited to two zone (prefilter/qualifying layer) membranes, but such exemplary microporous membranes are further contemplated to include microporous membranes having greater than two zones, e.g., three zone microporous membranes.

The dopes 26, 36 (and optionally dope 28), and quench bath 38 utilized in the fabrication of the microporous membrane herein are conventional in nature. The arrangement of slot dies 40, 42, 44 to first pressure impregnate the reinforcement layer/material 16 with a first dope and then to coat both sides thereof with other dopes has been found particularly effective to produce a three zone microporous membrane according to the present disclosure. As schematically depicted in FIG. 2, the disclosed method 50 may employ first die 40 for pressure impregnating reinforcement layer/material 16 and substantially opposed second and third dies 42, 44 for substantially simultaneously coating both sides 22, 24 of the initially impregnated reinforcement layer/material 16 to form a three zone microporous membrane. Omission of first die 40 or second die 42 is effective in fabricating a two zone microporous membrane according to the present disclosure.

The microporous membrane is thus generally produced according to the present disclosure by pressure impregnating the reinforcement layer/material 16 with appropriate dopes and immediately quenching the dopes in a bath 38 that contains a conventional nonsolvent system for the polymer(s). The development of micropores in the membrane having a desirable pore size distribution is generally achieved through selection of a solvent system for use with the polymer and a nonsolvent system for use in quenching the polymer film. Selection of a solvent for the polymer is generally determined by the nature of the polymer material used and can be empirically determined on the basis of solubility parameters, as is well known and conventional in the art.

The dopes for forming exemplary nylon microporous membranes according to the present disclosure generally contain nylon polymers in a solvent system for the polymer. The solvent system comprises a mixture of at least one solvent and one nonsolvent for the polymer. Solvents for use with alcohol soluble nylons include lower alkanols, e.g. methanol, ethanol and butanol, and mixtures thereof. It is known that nonalcohol soluble nylons will dissolve in solvents of acids, for example, formic acid, citric acid, acetic acid, maleic acid, and similar acids. The nylon dopes are generally diluted with a nonsolvent for the nylon, which is miscible with the nylon solution. Dilution with a nonsolvent may be effected up to the point of incipient precipitation of the nylon. Appropriate nonsolvents are generally selected on the basis of the nylon solvent utilized. For example, when water miscible nylon solvents are employed, water can be the nonsolvent. Generally, the nonsolvent may be selected from water, methyl formate, aqueous lower alcohols, such as methanol and ethanol, polyols such as glycerol, glycols, polyglycols, and ethers and esters thereof and mixtures of any of the foregoing.

The reinforcement layer/material 16 may be impregnated with the dopes by any of a variety of techniques, e.g., roll coating, spray coating, slot die coating, and the like, with slot die pressure impregnating being presently preferred, to substantially completely impregnate the reinforcement layer/material 16 with such dopes. The reinforcement layer/material 16 is preferably maintained under tension, in a manner known in the art, while the dopes, under pressure, penetrate and saturate the reinforcement layer/material 16. The impregnated reinforcement layer/material 16 can be calendered, if desired, by rollers to force the first coating solution into such layer/material, as described in U.S. Pat. No. 4,707,265 to Barnes, Jr., et al., the contents of which are incorporated by reference herein. Thereafter, the dopes are simultaneously quenched with the outer doped surfaces having direct contact with the quenching fluid in the same quench bath 38, and rinsed/washed. Quenching unit 38 is generally of conventional design and includes a conventional reservoir for circulating a quantity of nonsolvent for the dissolved polymer which causes the polymer in each of the dope zones to solidify.

Of note, to prevent or at least minimize vapors from the quench bath from contacting the dopes after the reinforcement layer/material 16 has been impregnated and coated on both sides with dopes, means, such as, for example, a controlled vapor zone, are generally provided for preventing or at least minimizing the quench bath vapors from interacting with the coated scrim before quench. This controlled vapor zone advantageously prevents dope from solidifying on the bottom of the dies and prevents quenching of the dope from contact with the vapors before the dope reaches the quench bath, as is known in the art.

The quenched microporous membrane is typically rinsed of excess fluid from the quench in a conventional first stage rinsing unit 70 immediately after the quenching process, as is known in the art. The membrane is thereafter generally directed over another plurality of rollers and into a counter-current flow wash tank 72, including a reservoir containing a quantity of water, a plurality of rollers to increase the contact time of the membrane within the tank 72, and suitable spraying and circulation apparatus, as are known in the art.

Once the microporous membrane is fabricated, e.g., as shown in FIG. 2, two microporous membrane elements are advantageously laminated to each other such that the qualifying zones are in side-by-side juxtaposition. Alignment and orientation of the microporous membrane elements with the qualifying zones in side-by-side orientation is achieved in any known manner, and lamination is effectuated according to known lamination techniques. Thus, the laminated microporous membrane is typically dried with the qualifying zones in a side-by-side spatial relationship to produce an advantageous multizone, laminated microporous membrane according to the present disclosure.

The described fabrication method/process can be conducted in a continuous or batch-wise manner in a number of representative apparatus. In general, the reinforcement layer/material 16, e.g., in the form of a nonwoven fibrous scrim, is unwound under tension from a roll and pressure impregnated with the dopes as described above. The unquenched dope/scrim combination is then substantially immediately immersed while still under tension in a quench bath, and rinsed/washed to form a microporous membrane element. Two microporous membrane elements may then be laminated to form the of a desired microporous membrane, which may be wound under tension on a roll for storage, as is known in the art.

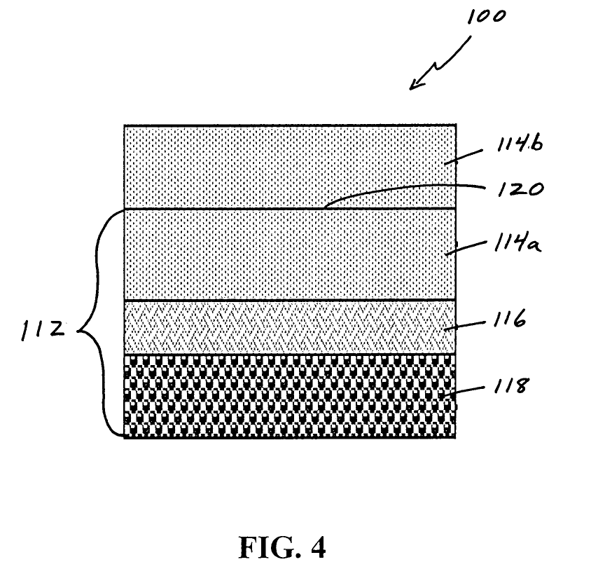

With reference to FIG. 4, a further presently preferred, exemplary microporous membrane 100 according to the present disclosure is schematically depicted. Microporous membrane 100 is formed by laminating microporous membrane member 112 to a qualifying layer 114b. Microporous membrane 112 includes a qualifying layer 114a, a reinforcement layer 116a (optional depending on fabrication material), and a prefilter layer 118. Lamination of microporous membrane member 112 to qualifying layer 114b advantageously places a first and second qualifying layer, i.e., qualifying layers 114a, 114b, in a side-by-side orientation along a lamination plane 120.

As with the disclosed microporous membrane of FIG. 1, lamination of the membrane member and the qualifying layer to each other along a lamination plane reduces the likelihood that a particle will be able to effectively navigate from a defect in a membrane element having a first qualifying layer to an independent defect in the second qualifying layer. The potential for particle(s) to navigate from defect-to-defect would be increased if the two qualifying layers were not effectively bonded to each other, thereby eliminating the potential for “free interchange” therebetweens. Reducing separation between the layers removes this free fluid interchange and the two defects must be in almost exact proximity with one another. As the proximity between the qualifying layers increases (and lamination according to the present disclosure significantly increases such proximity), the chance alignment of two defects becomes still more remote.

Lamination along a lamination plane according to an exemplary embodiment as depicted in FIG. 4 also reduces the effective thickness of the overall microporous membrane structure. The inevitable air gaps that exist between two unlaminated layers substantially reduces the amount of membrane surface area that can be packed into the filter cartridge. According to exemplary membrane embodiments of the present disclosure, lamination effectively removes the potential for such air gap(s).

A preferred microporous membrane 112 and qualifying layer 114b according to the present disclosure may be fabricated from nylon, polyvinylidene fluoride and/or polyethersulfone. Based on the structural properties of a microporous membrane fabricated from PVDF and/or PES, a reinforcement layer (e.g., layer 116) is generally not required. In the case of an unreinforced membrane, the prefilter layer and the qualifying layer would be adjacent to each other. Microporous membrane member 112 is typically continuous, i.e., a continuum exists between the filtering layers thereof.

It is believed that routine experimentation with substrates, pre-treatments, zone coating weights, polymers, dope viscosity, thickness, pore sizes, and orientations of the zones with respect to pore sizes consistent with and according to the present disclosure will yield optimized microporous membrane products which have superior performance to existing membrane products. Other membrane applications which will benefit from the ability to customize zone performance according to the principles of the present disclosure include (as examples) diagnostic products using body fluids, transfer membranes, separation devices, medical devices, and others which will become obvious to those skilled in the arts of membrane science.

To assist those of ordinary skill in the art to which the subject matter appertains in understanding how to construct and use the disclosed filter cartridge assemblies, the following illustrative examples are provided. However, the present application is not limited to the subject matter of these illustrative examples, either in whole or in part. Rather, the following examples are merely illustrative of exemplary embodiments of the present disclosure and are non-limiting in nature. For purposes of the following examples, the following terms shall have the following meanings:

“Bubble Point Test”—a method for determining filter integrity and pore size described by Brock in Membrane Filtration (1983), at pages 48-58.

“Diffusive Flow Test”—a method for specifically determining filter integrity described by Brock in Membrane Filtration (1983), at page 58.

“Filter Capacity”—the amount of material that can be filtered through a given filter device before it reaches a terminal operating pressure

“CFU”—colony forming unit.

“Sterilizing”—an accepted term described in the PDA Journal that describes the ability to remove microorganisms, specifically Brevundimonas Diminuta, in concentrations >10⁷ CFU/cm².

“In-Situ Steam Exposure”—pharmaceutical filters often undergo a sterilizing process prior to use. Two accepted methods are autoclaving and in-situ steaming. Filter robustness is often measured against these sterilizing procedures.

### EXAMPLE 1

Preparation of Individual Membrane Layers

Each individual membrane layer is constructed in accordance with U.S. Pat. No. 6,090,441 to Vining, Jr., et al. and U.S. Pat. No. 6,264,044 to Meyering et al. (the entire contents of which are hereby incorporated by reference). These two patents describe a continuous membrane casting process on a supported media. The Meyering '044 patent specifically describes the ability to manufacture up to (3) independent pore zones in one single layer of membrane (see, e.g., col. 10, line 1 et seq.).

The fabrication process disclosed in the Vining '441 and Meyering '044 patents is used to produce a membrane with enhanced filtration capacity characteristics by fabricating the membrane with a more open pore zone in the upstream layer. The more open zone acts as a built-in prefilter for the qualifying, tighter pore zone. The particle removal characteristics of membranes produced under these conditions are superior to single zone membranes.

### EXAMPLE 2

Production of Laminated Membranes

SAMPLE 2A: Cuno Zetapor 020SP is an exemplary laminated filtration product (control) having a laminated membrane that is sold as a sterilizing filter. The Zetapor 020SP product is constructed by casting two independent membrane layers. One layer is cast on a reinforcing support material (i.e., the support layer). The second layer (i.e., the qualifying layer) is cast in a non-reinforced manner. The two layers are then laminated to produce one homogenous membrane that is pleated into a filter device. Typically, lamination has occurred by placing individual layers of wet membrane in intimate contact and drying them under restrained conditions. The laminated membrane appears as one homogenous single layer membrane with no signs of separation in the two layers and, once laminated, individual layers are virtually undetectable.

SAMPLE 2B: According to the present disclosure, a membrane is fabricated with individual layers having at least (2) independent pore zones cast in each single membrane layer. Fabrication of the membrane layers having multiple pore zones is undertaken according to the procedure identified above. Two individual layers are then laminated such that the tighter, qualifying zones, of both layers are put together along the laminating plane. The more open, prefilter, zones are oriented on either side of the qualifying plane. The lamination of the membrane layers is undertaken according to the lamination procedure identified above. The final membrane structure corresponds to the structure schematically depicted in FIG. 1 and exhibits excellent robustness and superior filter capacity.

### EXAMPLE 3

Cartridge Fabrication Process

A filter device is constructed by pleating a laminated filter media according to the present disclosure (as described with reference to Sample 2B above) with upper and lower support materials. The pleated media is then sealed at the edges, by ultrasonic or heat sealing methods, to form a cylindrical shaped pack which is then inserted into an outer cage. An inner core is inserted into the center of the device as a downstream support. The ends of the device are treated with a wettability enhancing polymeric surface coating on the membrane, which is cured prior to capping. A preferred surface treatment is disclosed in commonly assigned, co-pending patent application entitled “Polymeric Surface Treatment of Filter Media,” filed simultaneously herewith (Ser. No. ______), the contents of which are hereby incorporated by reference. The filter device is then capped with a thermoplastic material by melt bonding or potting processes to seal the ends.

### EXAMPLE 4

Microorganism Retention Capability—Flatstock

As noted above, a sterilizing cartridge product may contain 1 m² of membrane surface area (typical cartridge constructions range from 0.46-1.02 m²) or 1 trillion square microns of surface area. If a single defect with a 5 micron diameter occurs within the media/membrane, the retention characteristics/properties of the media/membrane will be compromised. However, if the sterilizing cartridge product included another media layer of the same area with the same 5 micron diameter defect randomly located within it, the chance for alignment of the two defects would be only 0.00000031%.

Tests were performed on a series of samples fabricated according to the parameters described with reference to Sample 2B (see Example 2 hereof). The results of these tests are set forth in the following table and demonstrate that the disclosed filtration membrane exhibits the ability to retain an appropriate microorganism, thereby establishing the disclosed membranes as sterilizing grade filter media. The tested samples retained down to a bubble point of ˜37.5 psi in water.

Microbial Retention Results of Flatstock Membrane
(Brevudimonas Diminuta Challenge at >10⁷
CFU/cm² on a 142 mm disc)

| Sample ID | Bubble Point in H₂O (psi) | Sterile Effluent |
|---|---|---|
| Sample 1 | 40.0 | Yes |
| Sample 2 | 39.7 | Yes |
| Sample 3 | 39.5 | Yes |
| Sample 4 | 39.5 | Yes |
| Sample 5 | 39.0 | Yes |
| Sample 6 | 39.0 | Yes |
| Sample 7 | 38.7 | Yes |
| Sample 8 | 38.7 | Yes |
| Sample 9 | 37.9 | Yes |
| Sample 10 | 37.7 | Yes |
| Sample 11 | 37.4 | No |
| Sample 12 | 37.4 | Yes |
| Sample 13 | 36.9 | Yes |
| Sample 14 | 36.4 | Yes |
| Sample 15 | 35.6 | No |
| Sample 16 | 35.1 | No |
| Sample 17 | 35.1 | No |
| Sample 18 | 35.1 | Yes |
| Sample 19 | 34.8 | Yes |
| Sample 20 | 32.3 | No |

### EXAMPLE 5

Microbial Retention Capability—Pleated Devices

Tests were performed on a series of pleated filter devices fabricated according to Example 3 hereof. The results of these tests are set forth in the following table and demonstrate that the disclosed filter devices exhibit the ability to maintain their microbial retention characteristics after being constructed into a pleated device.

Microbial Retention Results of Cartridges
(Brevundimonas Diminuta Challenege at >10⁷
CFU/cm² on a 10″ Filter)

| | Water Wet Forward Diffusive Flow | |
|---|---|---|
| Sample ID | (35 psig air @ 25° C., cc/min) | Sterile Effluent |
| Sample 1 | 5.8 | Yes |
| Sample 2 | 5.9 | Yes |
| Sample 3 | 6.2 | Yes |
| Sample 4 | 6.3 | Yes |
| Sample 5 | 6.4 | Yes |
| Sample 6 | 9.8 | Yes |
| Sample 7 | 11.7 | Yes |
| Sample 8 | 13.3 | Yes |
| Sample 9 | 13.5 | Yes |
| Sample 10 | 16.2 | Yes |
| Sample 11 | 16.4 | Yes |
| Sample 12 | 17.1 | No |
| Sample 13 | 17.5 | Yes |
| Sample 14 | 17.5 | No |
| Sample 15 | 18.7 | No |
| Sample 16 | 18.9 | Yes |
| Sample 17 | 20.7 | No |
| Sample 18 | 21.3 | No |
| Sample 19 | 22.4 | No |
| Sample 20 | 23.2 | No |

### EXAMPLE 6

In-Situ Steam Tests of Filter Devices

A series of tests were peformed to determine the robustness of filter devices, based on repeated in-situ steam sterilization. The results of these tests are summarized in the following table (control and filter devices according to the present disclosure). The test results demonstrate the superior robustness of filter devices manufactured with processes outlined in Example 3.

Resistance to Repeat In-Situ Steam @ 126° C. 30 minute cycles

| | | Water Wet | | |
|---|---|---|---|---|
| | | Forward | | Water Wet Forward |
| | Steam | Diffusive | Steam | Diffusive Flow |
| Sample ID | Cycles | Flow @ 25° C. | Cycles | @ 25° C. |
| CUNO | | | | |
| Zetapor 020SP | | | | |
| 1 | 15 | Pass | 18 | Fail |
| 2 | 15 | Pass | 18 | Fail |
| 3 | 15 | Pass | 18 | Fail |
| Example 3 | | | | |
| 1 | 45 | Pass | 50 | Fail |
| 2 | 50 | Pass | 55 | Fail |
| 3 | 45 | Pass | 50 | Fail |
| 4 | 50 | Pass | 55 | Fail |
| 5 | 45 | Pass | 50 | Fail |
| 6 | 35 | Pass | 40 | Fail |

### EXAMPLE 7

Filtration Capacity of Pleated Device

A series of tests were conducted to determine the filtration capacity of pleated devices. The results of these tests are summarized in the following table (control and pleated devices according to the present disclosure). The test results demonstrate that pleated devices produced with processes outlined in Example 3 have superior capacity as compared to control filter devices.

Filter Capacity Testing
(Filter Life Testing 0f 0.2 um filters with a Constant
Flow rate of 3 GPM Contaminant is Molasses @
15.8 grams/liter and Kaolin Clay @ 0.1366 grams/liter)

| | Processed Volume @ 25 psid over |
|---|---|
| Sample ID | Initial Pressure (gal/ft² membrane) |
| CUNO Zetapor 020SP | |
| 1 | 2.1 |
| 2 | 2.6 |
| Filter Device | |
| According to Example 3 | |
| 1 | 7.4 |
| 2 | 7.1 |
| 3 | 6.7 |
| 4 | 6.7 |
| 5 | 7.7 |
| 6 | 7.6 |

Based on the foregoing description, it should now be apparent that the disclosed microporous membrane will carry out and/or satisfy the objects set forth hereinabove. It should also be apparent to those skilled in the art that the disclosed fabrication process/method may be practiced to manufacture a variety of advantageous laminated microporous membranes.

While the articles, apparatus and methods for making the articles contained herein constitute preferred embodiments of the present disclosure, it is to be understood that the disclosure is not limited to these precise articles, apparatus and methods, and that changes may be made therein without departing from the scope of the present invention which is defined in the appended claims.

What is claimed is:

1. A microporous filtration membrane, comprising:
a first membrane element that includes a first porous prefilter region and a first porous qualifying region; and
a second membrane element that includes a second porous prefilter region and a second porous qualifying region;
wherein said first membrane element and said second membrane element are laminated to each other such that said first qualifying region is in a side-by-side relation with said second qualifying region.

2. A microporous filtration membrane, comprising:
a first membrane element that includes a first porous prefilter region and a first porous qualifying region; and
a second membrane element that includes a second porous prefilter region and a second porous qualifying region;
wherein said first membrane element and said second membrane element are positioned in side-by-side orientation relative to each other such that said first qualifying region is in a side-by-side relation with said second qualifying region.

3. A microporous filtration membrane according to claim 2, wherein said first membrane element and said second membrane element are fabricated from a nylon.

4. A microporous filtration membrane according to claim 2, wherein said first membrane element and said second membrane element are fabricated from a fluoropolymer.

5. A microporous filtration membrane according to claim 3, wherein said fluoropolymer is polyvinylidene fluoride.

6. A microporous filtration membrane according to claim 2, wherein said first membrane element and said second membrane element are fabricated from polyethersulfone.

7. A microporous filtration membrane according to claim 2, further comprising a first reinforcement layer intermediate said first prefilter region and said first qualifying region, and a second reinforcement layer intermediate said second prefilter region and said second qualifying region.

8. A microporous filtration membrane according to claim 7, wherein said first reinforcement layer and said second reinforcement layer are fabricated on a non-porous support material.

9. A microporous filtration membrane according to claim 8, wherein said non-porous support material is a polyethylene terephthalate film.

10. A microporous filtration membrane according to claim 2, wherein said first porous prefilter region and said first porous qualifying region define a pore size ratio that is about 1.5:1 to about 4:1.

11. A method of fabricating a laminated microporous membrane comprising the steps of:
providing a nonwoven reinforcement material having first and second sides;
impregnating the support material with a first dope on said first side and a second dope on said second side;
treating said impregnated support material such that said first dope is phase inverted to define a prefilter layer and said second dope is phase inverted to define a qualifying layer; and
laminating a first segment of said phase inverted, impregnated support material to a second segment of said phase inverted, impregnated support material such that said qualifying layer of said first segment is in side-by-side relation to said qualifying region of said second segment.

12. The method of claim 11, wherein, said first and second dopes are formulated and phase inverted to produce a pore size ratio between said prefilter layer and said qualifying layer of about 1.5:1 to about 4:1.

13. The method of claim 11, further comprising applying a third dope to said impregnated support material.

14. The method of claim 11, further comprising rinsing and washing said phase inverted, impregnated support material prior to said lamination step.

15. The method of claim 11, wherein said support material is fabricated from a material selected from the group consisting of polyolefins and polyesters.

16. The method of claim 11, wherein said treatment step comprises quenching said impregnated support material.

17. The method of claim 11, wherein said lamination step includes at least one of the following processing steps: (i) pressing said first and second segments together with a nip roller prior to drying, or (ii) placing said first and second segments in intimate contact and processing in a vacuum roll dryer.

18. A laminated microporous filtration membrane, comprising:
a first membrane element that includes a first porous prefilter region, a first reinforcement layer, and a first porous qualifying region; and
a second membrane element that includes a second porous prefilter region, a second reinforcement layer, and a second porous qualifying region;
wherein said first membrane element and said second membrane element are laminated to each other along a lamination plane such that said first qualifying region is in a side-by-side relation with said second qualifying region.

19. A laminated microporous filtration membrane, comprising:
a first membrane element that includes a first porous prefilter region and a first porous qualifying region; and
a second membrane element that includes a second porous qualifying region;
wherein said first membrane element and said second membrane element are laminated to each other such that said first qualifying region is in a side-by-side relation with said second qualifying region.

20. A microporous filtration membrane, comprising:
a first membrane element that includes a first porous prefilter region and a first porous qualifying region; and
a second membrane element that includes a second porous prefilter region and a second porous qualifying region;
wherein said first membrane element and said second membrane element are adjoined, but not laminated, to each other such that said first qualifying region is in a side-by-side relation with said second qualifying region.
